(19) United States
(12) Patent Application Publication
(10) Pub. No.: US 2019/0354482 A1
(43) Pub. Date: Nov. 21, 2019

(54) TIME-BASED MECHANISM SUPPORTING FLUSH OPERATION

(71) Applicant: Microsoft Technology Licensing, LLC, Redmond, WA (US)

(72) Inventor: Scott Chao-Chueh LEE, Bellevue, WA (US)

(21) Appl. No.: 15/985,156

(22) Filed: May 21, 2018

(51) Int. Cl. G06F 12/0804; G06F 12/0891; G06F 3/06

(52) U.S. Cl. CPC G06F 12/0804; G06F 3/0679; G06F 3/061; G06F 12/0891

(57) ABSTRACT

The techniques disclosed herein improve performance of storage systems by providing a time-based mechanism for supporting a flush operation. In one embodiment, a flush completion time stamp is accessed that is indicative of a most recent time of completion of a cache flush by a cache flush function. The flush completion time stamp is compared with a time stamp associated with a cache flush request. Based on the comparing, an indication is generated that the requested cache flush is complete when the flush completion time stamp is more recent than the time stamp associated with the cache flush request.

### BACKGROUND

Non-volatile storage and volatile storage are typically used in computing systems. Non-volatile storage may include storage technologies such as disk drives, SSD, and SCM. Non-volatile storage device allows information to be stored or retained even when the non-volatile storage device is not connected to a power source. In contrast, the content of volatile storage, such as volatile cache, may be lost when the volatile memory device is disconnected from a power source. Each type of storage exhibits trade-offs between access time, throughput, capacity, volatility, cost, etc.

Storage devices may include a memory controller and one or more volatile memory devices and one or more non-volatile storage devices. A storage device may store data to be written to non-volatile memory in a cache. The contents of the cache may be written to non-volatile memory based on one or more conditions. For example, after sufficient data are available in the cache to fill a write block, a full write block of data may be written from the cache to the non-volatile memory. In certain circumstances, a device (e.g., a host) coupled to the data storage device may issue a flush command to clear the cache. In response to receiving the flush command, the storage device may write the data in the cache to the non-volatile memory.

It is with respect to these and other considerations that the disclosure made herein is presented.

### SUMMARY

Persistent or non-volatile storage is included in many computing systems, and the improvements described herein provide a technical solution to a problem inherent to computing—how to efficiently and securely determine that the data temporarily stored in a cache has been stored in the persistent memory of the computing system.

Various embodiments of the present disclosure provide ways to improve operation of a storage cache that supports storage functions. When using a cache, data that is stored in cache should be moved and stored to persistent media before the cache is cleared or used for other data. Therefore, it is important to know when the data in the cache has been safely stored in persistent storage. For example, a flush command may be issued to move data in the cache to persistent storage. However, the size of the cache may be large and it may take some time to transfer the data to persistent storage. Without an accurate way to determine when the data in cache has been stored, the memory controller may wait an unnecessarily long time to wait to ensure safe storage of the data. Additionally, the memory controller may unnecessarily poll for data to determine if the cached data has been stored.

The present disclosure describes a way to efficiently and quickly determine when cached data has been moved to persistent storage, thus addressing the shortcomings described herein and therefore improving the efficiency and reliability with which the cache may be utilized and avoiding unnecessary latencies and resource usage.

In one embodiment, a flush engine may be implemented that continuously flushes any dirty cache data. In various embodiments, the flush may be performed at a predetermined interval or based on some other trigger or schedule. With the continuous operation of the flush engine, the operating system or other component may determine when the flush engine has completed one cycle or round of a cache flush in order to determine if the data in the cache has been stored in persistent memory.

In one embodiment, a time stamp may be provided that is indicative of when the current flush cycle has been completed. If a request for a flush operation is received, the time stamp of the request may be compared to the time stamp of the flush completion indication. If the time stamp of the flush completion indication is later or more recent than the time stamp of the request for the flush operation, then it can be determined that the data that was in the cache at the time of the flush request has been persisted to storage.

In one embodiment, an application programming interface (API) may be implemented to allow applications to submit a request for the cache to be flushed. In response to the request, the time stamp for when the request was received can be stored. In one embodiment, the flush engine can be queried to determine the time stamp of the last cache flush completion. Once a time stamp is received that is more recent than the time stamp of the request, the API request can be completed by returning an indication that the flush operation has been completed. Optionally or alternatively, the requesting application may be able to access a register than includes the most current completion time of a flush operation.

In this manner, completion of the cache flush can be determined efficiently by comparing time stamps. In particular, in some embodiments only the time stamp of one completion of the flush engine is needed to determine if the flush has been completed.

In one embodiment, a flush function may be implemented that is configured to perform a cache flush on a periodic or other time-based basis, or based on some command or condition. For example, the flush function may determine if the cache has dirty data, and in response to determining that the cache has dirty data, cause the contents of the cache to be written to persistent storage. Once the data has been written to persistent storage, the flush function, or another function, may determine the time when the flush was completed, and write the time in a predetermined location such as a register. The location may be accessed by an application to compare the flush completion time with another event of interest. Since only the most recent time may be of interest, a history of flush completion times need not be maintained. An application or other user need only read the stored location to determine the latest flush completion time. In this way, the usage of registers or other memory can be minimized, and the mechanism for accessing the information may be more efficient. In some embodiments, an API may be provided to request the flush completion time stamp.

In an embodiment, completion of a flush request may be determined by comparing the time stamp of the flush request and the time stamp of the latest flush completion. For example, if the time of flush completion is later than the time of the flush request, then the flush request may be considered as completed. If the flush request has not been completed, then the requesting application may wait until the next updated time stamp for the flush completion is available. In some cases, the flush time may have requested or accessed on a continuous basis until a new value is written to the flush completion register.

In one embodiment, an estimated time of completion of a flush operation may be provided that can be used to determine how long a user or application should wait until the next request for or access to the flush completion time. In an embodiment, the estimated time of completion of a flush operation may be provided in another register location.

In another embodiment, a notification may be provided that indicates that a new flush completion time is available. This may allow requesting applications and users to wait until the notification is received rather than continuously polling for an updated flush completion time or using an estimated time where at least some of the time the estimate may nevertheless result in excess requests or accesses to the flush completion time. Estimated flush completion times may vary due to variability of the amount of data in the cache, as well as variability in the speed settings in the flush engine. In some embodiments, the notification of a flush completion may be provided via an interrupt. In an embodiment, the notification of a flush completion may be provided through an ACPI notification.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, same reference numbers in different figures indicate similar or identical items.

FIG. 1 illustrate an example computer architecture for a computer capable of implementing a time-based mechanism as described herein.

FIG. 2 illustrates an example of a time-based mechanism for flush operations in one embodiment.

FIG. 3 is a flow diagram of an illustrative process for a time-based mechanism for flush operations in accordance with the present disclosure.

FIG. 4 is a flow diagram of an illustrative process for a time-based mechanism for flush operations in accordance with the present disclosure.

FIG. 5 is a flow diagram of an illustrative process of a time-based mechanism for flush operations in accordance with the present disclosure.

### DETAILED DESCRIPTION

The following Detailed Description describes methods and systems for implementing a time-based mechanism supporting a flush operation. Various embodiments of the present disclosure describe ways to improve durability of data writes when using a cache. When using a cache, it is important to ensure that data that is stored in cache is moved and stored to persistent media before the cache is cleared or used for other data.

In an example implementation, a memory controller or other component may issue a command to move the data in the cache to persistent storage. One technical issue in ensuring that cached data is persisted is to determine when the data in the cache has been safely stored in persistent memory. For example, a flush command may be issued to move data in the cache to persistent storage. However, the size of the cache may be large and it may take some time to transfer the data to persistent storage. Without an accurate way to determine when the data in cache has been stored, the memory controller may wait an unnecessarily long time to wait to ensure safe storage of the data, or the memory controller may unnecessarily poll for data to determine if the cached data has been stored.

The present disclosure describes a way to efficiently and quickly determine when cached data has been moved to persistent storage, thus addressing the shortcomings described above and therefore improving the efficiency with which the cache may be utilized and avoiding unnecessary latencies and resource usage.

In one embodiment, a flush engine or mechanism may be implemented that continuously flushes any dirty cache data. The flush engine or mechanism may be implemented in hardware, software, or a combination thereof. In the present disclosure, a flush engine may also be referred to as a flush mechanism or a flush function. The flush engine may be implemented in hardware, software, or a combination.

In various embodiments, the cache flush may be performed at a predetermined interval or based on some other trigger or schedule. With the operation of the flush engine, the operating system or other component may determine when the flush engine has completed one cycle or round of a cache flush in order to determine if the data in the cache has been stored in persistent memory.

In one embodiment, a time stamp may be provided that is indicative of when the current flush cycle has been completed. If a request for a flush operation is received, the time stamp of the request may be compared to the time stamp of the flush completion indication. If the time stamp of the flush completion indication is later or more recent than the time stamp of the request for the flush operation, then it can be determined that the data at the time of the request has been stored in persistent memory.

In one embodiment, an application programming interface (API) can be implemented to allow applications to submit a request for the cache to be flushed. In response to the request, the time stamp for when the request was received can be stored. In one embodiment, the flush engine can be queried to determine the time stamp of the last cache flush completion. Once a time stamp is received that is more recent than the time stamp of the request, the API request can be completed by returning an indication that the flush operation has been completed.

In this manner, completion of the cache flush can be determined efficiently by comparing time stamps. In particular, only the time stamp of one completion of the flush engine is needed to determine if the flush has been completed. Furthermore, by allowing for quick and efficient determination of a flush completion, data integrity as well as data security may be improved.

In one embodiment, a flush function may be implemented that is configured to perform a cache flush on a periodic or other time-based basis, or based on some command or condition. For example, the flush function may determine if the cache has dirty data, and in response to determining that the cache has dirty data, the flush function may cause the contents of the cache to be written to persistent storage. Once the data has been written to persistent storage, the flush function, or another function, may determine the time when the flush was completed, and write the time in a predetermined location such as a register.

The register location may be accessed by an application to compare the flush completion time with another event of interest. Since only the most recent time may be of interest, a history of flush completion times need not be maintained. An application or other user need only read the stored location to determine the latest flush completion time. In this way the usage of registers or other memory can be minimized, and the mechanism for accessing the information may be provided in a more efficient manner. In some embodiments, an API may be provided to request the flush completion time stamp.

In an embodiment, completion of a flush request may be determined by comparing the time stamp of the flush request and the time stamp of the latest flush completion. For example:

If Tₛ(flush completion)>Tₛ(flush request)=TRUE

Then the flush request is completed. However,

If Tₛ(flush completion)<Tₛ(flush request)=TRUE

Then the flush request has not been completed.

If the flush request has not been completed, then the requesting application may wait until the next updated time stamp for the flush completion. The requesting application may also need to continue to access the flush time or request the flush time to determine when a new value is written to the flush completion register.

In one embodiment, an estimated time of completion of a flush operation may be provided that can be used to determine how long a user or application should wait until the next request or access to the flush completion time. In an embodiment, the estimated time of completion of a flush operation may be provided in another register location.

In another embodiment, a notification may be provided that indicates that a new flush completion time is available. This will allow requesting applications and users to wait until the notification is received rather than continuously polling for an updated flush completion time or using an estimated time where at least some of the time the estimate may nevertheless result in excess requests or accesses to the flush completion time. Estimated flush completion times may vary due to variability of the amount of data in the cache, as well as variability in the speed settings in the flush engine. In some embodiments, the notification of a flush completion may be provided via an interrupt. In an embodiment, the notification of a flush completion may be provided through an ACPI notification.

As used herein, “persistent memory” may refer to a memory device that retains information when power is withdrawn. Persistent memory may be addressable over a memory bus.

As used herein, “volatile memory” refers to a storage device that loses data when the device's power supply is interrupted. Power may be interrupted due to a power outage, battery exhaustion, manual reboot, scheduled reboot, or the like.

Non-volatile memory may use memory cells that include one or more memory technologies, such as a flash memory (e.g., NAND, NOR, Multi-Level Cell (MLC), Divided bit-line NOR (DINOR), AND, high capacitive coupling ratio (HiCR), asymmetrical contactless transistor (ACT), or other Flash memory technologies), a Resistive Random Access Memory (RRAIVI or ReRAM), or any other type of memory technology. The memory cells of non-volatile memory may be configured according to various architectures, such as a byte modifiable architecture or a non-byte modifiable architecture (e.g., a page modifiable architecture).

Non-volatile memory also may include support circuitry, such as read/write circuits. Read/write circuits may be a single component or separate components, such as read circuitry and write circuitry.

In an embodiment, a data storage device may be coupled to a host device and configured as embedded memory. In another embodiment, the data storage device may be a removable device that is removably coupled to host device. For example, the data storage device may be a memory card. A data storage device may operate in compliance with a JEDEC industry specification, one or more other specifications, or a combination thereof. For example, the data storage device may operate in compliance with a USB specification, a UFS specification, an SD specification, or a combination thereof.

The data storage device may be coupled to the host device indirectly, e.g., via one or more networks. For example, the data storage device may be a network-attached storage (NAS) device or a component (e.g., a solid-state drive (SSD) device) of a data center storage system, and enterprise storage system or a storage area network.

The host device may generate commands (e.g., read commands, write commands, flush commands, or other commands) for the data storage device.

Many processing devices utilize caches to reduce the average time required to access information stored in a memory. A cache is typically a smaller and faster memory that stores copies of instructions and/or data that are expected to be used relatively frequently. A cache may be implemented as embedded memory in a persistent storage such as a hard disk drive (HDD). The cache may act as a buffer between other functions of the computer and the persistent storage.

For example, central processing units (CPUs) may use a cache or a hierarchy of cache memory elements. Processors other than CPUs, such as, for example, graphics processing units and others, may also use caches. Instructions or data that are expected to be used by the CPU may be moved from main memory into the cache. When the CPU needs to read or write a location in the main memory, the CPU may first check to see whether the desired memory location is included in the cache memory. If this location is included in the cache, then the CPU can perform the read or write operation on the copy in the cache memory location. If this location is not included in the cache, then the CPU must access the information stored in the main memory and, in some cases, the information can be copied from the main memory and added to the cache.

Caches are typically flushed prior to powering down the CPU or some other event. Flushing the cache may include writing back modified or “dirty” cache lines to the main memory or persistent memory and optionally invalidating the lines in the cache. Microcode can be used to sequentially flush different cache elements in the CPU cache. Cache flushing may be performed, for example, for some instructions performed by the CPU. Cache flushing may also be performed to support powering down the CPU for various power saving states. Cache flushing may therefore be performed frequently. Performing flushing of the caches may take a number of clock cycles in typical embodiments, although the number of clock cycles may vary depending on the size of the caches and other factors.

A cache controller may be implemented to control and coordinate flushing the caches. Persons of ordinary skill in the art should appreciate that in various embodiments portions of the cache controller may be implemented in hardware, firmware, software, or any combination thereof. Moreover, the cache controller may be implemented in other locations internal or external to the CPU.

The cache controller may be electronically and/or communicatively coupled to the cache. In some embodiments, other elements may intervene between the cache controller and the caches. In the interest of clarity, the present description does not describe all of the interconnections and/or communication pathways between the elements in the devices described herein.

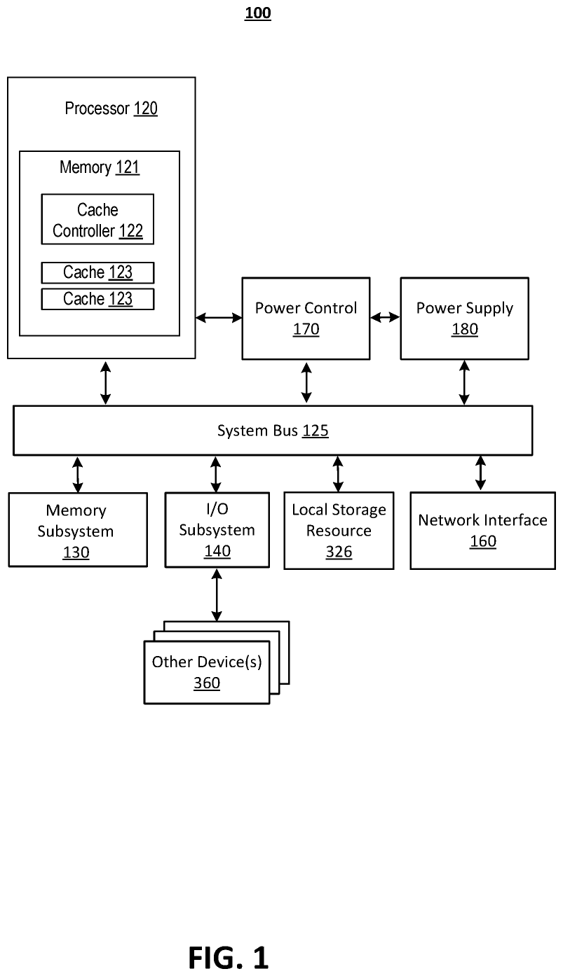

Turning to the drawings, FIG. 1 illustrates a block diagram depicting selected elements of an embodiment of a computing environment 100. As described herein, computing environment 100 may represent a personal computing device, such as a personal computer system, a desktop computer, a laptop computer, a notebook computer, etc.

As shown in FIG. 1, components of computing environment 100 may include, but are not limited to, processor subsystem 120, which may comprise one or more processors, and system bus 125 that communicatively couples various system components to processor subsystem 120 including, for example, a memory subsystem 130, an I/O subsystem 140, local storage resource 150, and a network interface 160. System bus 125 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In FIG. 1, network interface 160 may be a suitable system, apparatus, or device operable to serve as an interface between computing environment 100 and a network (not shown in FIG. 1). Network interface 160 may enable computing environment 100 to communicate over the network using a suitable transmission protocol and/or standard, including, but not limited to, transmission protocols and/or standards. In some embodiments, network interface 160 may be communicatively coupled via the network to a network storage resource (not shown). The network coupled to network interface 160 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). The network coupled to network interface 160 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. The network coupled to network interface 160 and/or various components associated therewith may be implemented using hardware, software, or any combination thereof.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130). In the same or alternative embodiments, processor subsystem 120 may interpret and/or execute program instructions and/or process data stored remotely (e.g., in a network storage resource, not shown).

As illustrated in FIG. 1, a memory subsystem 121 within processor subsystem 120 may include multiple data caches. A cache controller 122 within memory subsystem 121 may include circuitry to manage the contents of one or more caches 123. For example, cache controller 122 may include circuitry to determine when and if an individual cache line or a group of cache lines should be evicted from one of the caches in accordance with a policy. In at least some embodiments, cache controller 122 may also include circuitry to limit the amount of modified (dirty) cached data that would be flushed to persistent memory upon a system power failure or other power loss event, in response to requests and commands, or other events.

In FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down. Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Each of the processes, methods and algorithms described herein may be embodied in, and fully or partially automated by, code modules executed by one or more computers or computer processors as depicted in FIG. 1. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage. For purposes of the claims, the phrase “computer storage medium,” “computer-readable storage medium,” and variations thereof, does not include waves, signals, and/or other transitory and/or intangible communication media, per se.

In system 100, I/O subsystem 140 may comprise a system, device, or apparatus generally operable to receive and/or transmit data to/from/within computing environment 100. I/O subsystem 140 may represent, for example, a variety of communication interfaces, graphics interfaces, video interfaces, user input interfaces, and/or peripheral interfaces. As shown, I/O subsystem 140 may further communicate with various I/O devices such as a touch panel and display adapter.

As illustrated in FIG. 1, computing environment 100 may include one or more power control modules 170 and one or more power supply units (PSUs) 180. In at least some embodiments, power control modules 170 may include power distribution circuitry. In at least some embodiments, power control module(s) 170 may control the allocation of power generated by one or more of the power supply units (PSUs) 180 to other resources in system 100. In some embodiments, one or more of the power control modules 170 may include a management controller (MC).

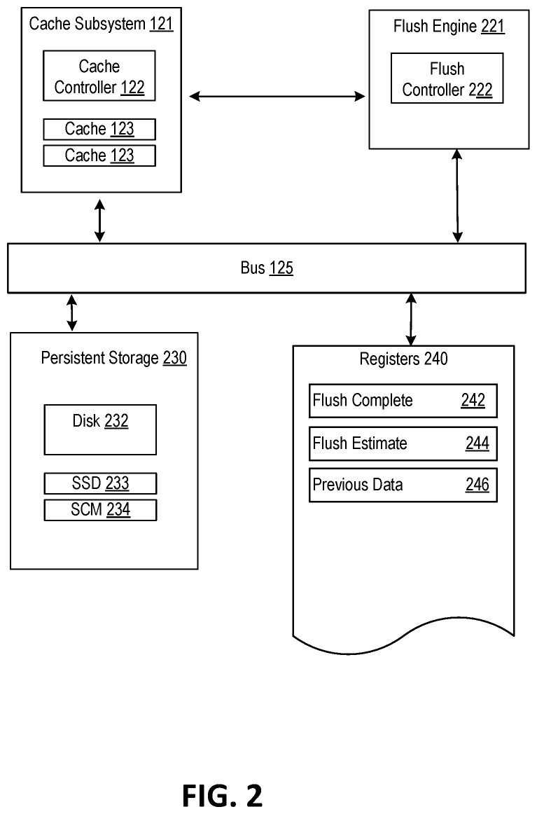

FIG. 2 illustrates a block diagram depicting selected elements of an embodiment of a time-based mechanism supporting a flush operation. As illustrated in FIG. 2, a memory subsystem 121 may include multiple data caches 123. A cache controller 122 within memory subsystem 121 may include circuitry to manage the contents of one or more caches 123. A flush engine 221 may include a flush controller 222. The flush engine 221 may be configured to continuously, periodically, or otherwise at some predetermined timing, perform or cause a cache flush.

Connected to bus 125, persistent storage 230 may include hard disk 232, SSD 233, and SCM 234. Also illustrated in FIG. 2 is an example of registers 240 that is operable to store a flush complete time 242, flush complete estimated time 244, and in some embodiments a previous flush complete time 246. This may be the previous flush complete time, or some other predetermined value.

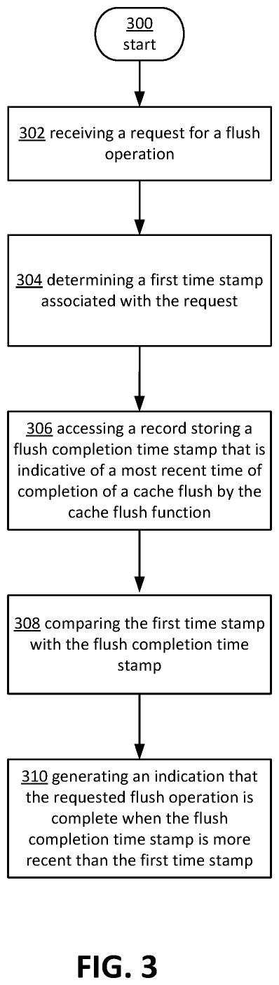

Referring to FIG. 3 is an example process for performing a memory operation in a computing system where a cache flush function is implemented. Operation 302 illustrates receiving a request for a flush operation. Operation 304 illustrates determining a first time stamp associated with the request. Operation 304 may be followed by operation 306. Operation 306 illustrates accessing a record storing a flush completion time stamp that is indicative of a most recent time of completion of a cache flush by the cache flush function. Operation 306 may be followed by operation 308. Operation 308 illustrates comparing the first time stamp with the flush completion time stamp. Operation 308 may be followed by operation 310. Operation 310 illustrates based on the comparing, generating an indication that the requested flush operation is complete when the flush completion time stamp is more recent than the first time stamp.

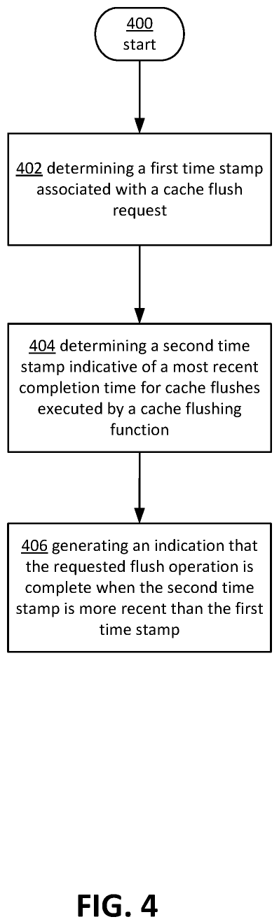

Referring to FIG. 4, illustrated is an example operational procedure in accordance with the present disclosure. Referring to FIG. 4, Operation 400 begins the procedure. Operation 400 may be followed by Operation 402. Operation 402 illustrates determining a first time stamp associated with a cache flush request. Operation 402 may be followed by Operation 404. Operation 404 illustrates determining a second time stamp indicative of a most recent completion time for cache flushes executed by a cache flushing function. Operation 404 may be followed by Operation 406. Operation 406 illustrates generating an indication that the requested flush operation is complete when the second time stamp is more recent than the first time stamp.

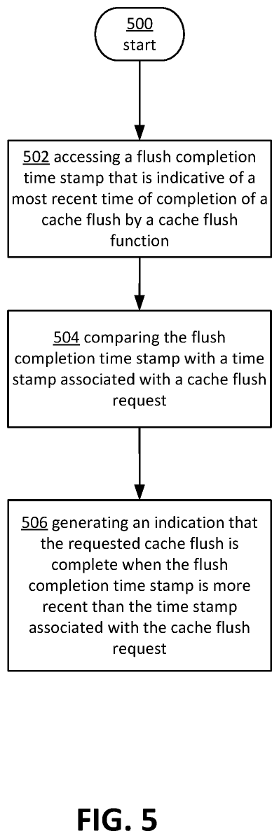

Referring to FIG. 5, illustrated is an example operational procedure in accordance with the present disclosure. Referring to FIG. 5, Operation 500 begins the procedure. Operation 500 may be followed by Operation 502. Operation 502 illustrates accessing a flush completion time stamp that is indicative of a most recent time of completion of a cache flush by a cache flush function. Operation 502 may be followed by Operation 504. Operation 504 illustrates comparing the flush completion time stamp with a time stamp associated with a cache flush request. Operation 504 may be followed by Operation 506. Operation 506 illustrates based on the comparing, generating an indication that the requested cache flush is complete when the flush completion time stamp is more recent than the time stamp associated with the cache flush request.

The disclosure presented herein may be considered in view of the following clauses.

Example Clause A, a computer-implemented method for performing a memory operation in a computing system where a cache flush function is implemented, the method comprising:

receiving a request for a flush operation;

determining a first time stamp associated with the request;

accessing a record storing a flush completion time stamp that is indicative of a most recent time of completion of a cache flush by the cache flush function;

comparing the first time stamp with the flush completion time stamp;

based on the comparing, generating an indication that the requested flush operation is complete when the flush completion time stamp is more recent than the first time stamp.

Example Clause B, the computer-implemented method of Example Clause A, wherein the request for the flush operation and the indication that the request flush operation is complete is communicated via an application programming interface (API).

Example Clause C, the computer-implemented method of any one of Example Clauses A through B, wherein cache flush function is configured to:

flush the cache based on one or more conditions; and

update the record with updated flush completion time stamps each time the cache is flushed.

Example Clause D, the computer-implemented method of any one of Example Clauses A through C, wherein the one or more conditions comprise one or more of: the cache is dirty, a predetermined time period has elapsed, or a flush request is received.

Example Clause E, the computer-implemented method of any one of Example Clauses A through D, wherein the record is accessed in response a notification that an updated flush completion time stamp is available.

Example Clause F, the computer-implemented method of any one of Example Clauses A through E, wherein the notification is a programming interrupt.

Example Clause G, the computer-implemented method of any one of Example Clauses A through F, wherein the record is accessed based on a time estimate of a flush completion.

Example Clause H, a computing device comprising:

one or more processors;

a memory in communication with the one or more processors, the memory having computer-readable instructions stored thereupon which, when executed by the one or more processors, cause the computing device perform operations comprising:

determining a first time stamp associated with a cache flush request;

determining a second time stamp indicative of a most recent completion time for cache flushes executed by a cache flushing function; and

generating an indication that the requested flush operation is complete when the second time stamp is more recent than the first time stamp.

Example Clause I, the computing device of Example Clause H, wherein the second time stamp is obtained from a storage location that stores the most recent completion time for cache flushes.

Example Clause J, the computing device of any one of Example Clauses H through I, wherein cache flush function is configured to:

flush the cache based on one or more conditions; and

update the storage location with updated flush completion time stamps each time the cache is flushed.

Example Clause K, the computing device of any one of Example Clauses H through J, further comprising computer-readable instructions stored thereupon which, when executed by the one or more processors, cause the computing device perform operations comprising instantiating an API operable to:

receive electronic messages indicative of the cache flush request; and

send electronic messages indicative of the indication that the requested flush operation is complete.

Example Clause L, the computing device of any one of Example Clauses H through K, wherein the storage location is accessed in response a notification that an updated completion time is available.

Example Clause M, the computing device of any one of Example Clauses H through L, further comprising computer-readable instructions stored thereupon which, when executed by the one or more processors, cause the computing device perform operations comprising:

receiving an estimated time for completion of a flush operation; and

waiting for the estimated time to elapsed before accessing the storage location.

Example Clause N, the computing device of any one of Example Clause H through M, wherein the notification is a programming interrupt.

Example Clause O, the computing device of any one of Example Clauses H through N, wherein the one or more conditions comprise one or more of: the cache is dirty, a predetermined time period has elapsed, or a flush request is received.

Example Clause P, the computing device of any one of Example Clauses H through O, further comprising computer-readable instructions stored thereupon which, when executed by the one or more processors, cause the computing device perform operations comprising waiting for an additional time to access the storage location when the first time stamp is more recent than the second time stamp.

Example Clause Q, a computing device comprising a processor and a computer-readable storage medium having stored thereon computer-readable instructions stored thereupon which, when executed by the processor, cause the computing device to perform operations comprising:

accessing a flush completion time stamp that is indicative of a most recent time of completion of a cache flush by a cache flush function;

comparing the flush completion time stamp with a time stamp associated with a cache flush request; and

based on the comparing, generating an indication that the requested cache flush is complete when the flush completion time stamp is more recent than the time stamp associated with the cache flush request.

Example Clause R, the computer-readable storage medium of Example Q, wherein the flush completion time stamp is updated each time a cache flush is completed.

Example Clause S, the computer-readable storage medium of any one of Example Q through R, wherein the flush completion time stamp is stored in a register that is updated each time a cache flush is completed.

Example Clause T, the computer-readable storage medium of any one of Example Clauses Q through S, wherein the flush completion time stamp is accessed in response to an indication that the flush completion time stamp has been updated.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

1. A computer-implemented method for performing a memory operation in a computing system where a cache flush function is implemented, the method comprising:
receiving a request for a flush operation;
determining a first time of the request;
accessing a record storing a flush completion time indicative of a most recent time of completion of a cache flush by the cache flush function, wherein the cache flush function is configured to continuously perform a cache flush on a time-based basis or in response to a condition;
comparing the first time with the flush completion time; and
based on the comparing, generating an indication that the requested flush operation is complete when the flush completion time is more recent than the first time.

2. The computer-implemented method of claim 1, wherein the request for the flush operation and the indication that the request flush operation is complete is communicated via an application programming interface (API).

3. The computer-implemented method of claim 1, wherein cache flush function is configured to:
flush the cache based on one or more conditions; and
update the record with additional flush completion time stamps each time the cache is flushed.

4. The computer-implemented method of claim 3, wherein the one or more conditions comprise one or more of: the cache is dirty, a predetermined time period has elapsed, or a flush request is received.

5. The computer-implemented method of claim 1, wherein the record is accessed in response to a notification that an updated flush completion time stamp is available.

6. The computer-implemented method of claim 5, wherein the notification is a programming interrupt.

7. The computer-implemented method of claim 1, wherein the record is accessed based on a time estimate of a flush completion.

8. A computing device comprising:
one or more processors;
a memory in communication with the one or more processors, the memory having computer-readable instructions stored thereupon which, when executed by the one or more processors, cause the computing device perform operations comprising:
determining a first time stamp associated with a cache flush request;
determining a second time stamp indicative of a most recent completion time for cache flushes executed by a cache flushing function that is configured to continuously perform a cache flush on a time-based basis or in response to a condition; and
generating an indication that the requested cache flush is complete when the second time stamp is more recent than the first time stamp.

9. The computing device of claim 8, wherein the second time stamp is obtained from a storage location that stores the most recent completion time for cache flushes.

10. The computing device of claim 9, wherein cache flush function is configured to:
flush the cache based on one or more conditions; and
update the storage location with updated flush completion time stamps each time the cache is flushed.

11.The computing device of claim 8, further comprising computer-readable instructions stored thereupon which, when executed by the one or more processors, cause the computing device perform operations comprising instantiating an API operable to:
receive electronic messages indicative of the cache flush request; and
send electronic messages indicative of the indication that the requested cache flush is complete.

12. The computing device of claim 9, wherein is accessed in response a notification that an updated completion time is available.

13. The computing device of claim 9, further comprising computer-readable instructions stored thereupon which, when executed by the one or more processors, cause the computing device perform operations comprising:
receiving an estimated time for completion of a flush operation; and
waiting for the estimated time to elapsed before accessing the storage location.

14. The computing device of claim 12, wherein the notification is a programming interrupt.

15. The computing device of claim 10, wherein the one or more conditions comprise one or more of: the cache is dirty, a predetermined time period has elapsed, or a flush request is received.

16. The computing device of claim 13, further comprising computer-readable instructions stored thereupon which, when executed by the one or more processors, cause the computing device perform operations comprising waiting for an additional time to access the storage location when the first time stamp is more recent than the second time stamp.

17. A computing device comprising a processor and a computer-readable storage medium having stored thereon computer-readable instructions stored thereupon which, when executed by the processor, cause the computing device to perform operations comprising:
accessing a flush completion time stamp that is indicative of a most recent time of completion of a cache flush by a cache flush function configured to continuously perform a cache flush on a time-based basis or in response to a condition;
comparing the flush completion time stamp with a time stamp associated with a cache flush request; and
based on the comparing, generating an indication that the requested cache flush is complete when the flush completion time stamp is more recent than the time stamp associated with the cache flush request.

18. The computing device of claim 17, wherein the flush completion time stamp is updated each time a cache flush is completed.

19. The computing device of claim 17, wherein the flush completion time stamp is stored in a register that is updated each time a cache flush is completed.

20. The computer-readable storage medium of claim 19, wherein the flush completion time stamp is accessed in response to an indication that the flush completion time stamp has been updated.
